(19) United States
(12) Patent Application Publication
(10) Pub. No.: US 2006/0176502 A1
(43) Pub. Date: Aug. 10, 2006

(54) Method and system for calculating an order pick-up time for an order to process digital images

(76) Inventors: Scott Brownstein, Rochester, NY (US); Jeff Bloom, Rochester, NY (US)

Correspondence Address: STROOCK & STROOCK & LAVAN LLP, 180 MAIDEN LANE, NEW YORK, NY, 10038, US

(21) Appl. No.: 11/053,635

(22) Filed: Feb. 7, 2005

(51) Int. Cl. G06F 3/12

(52) U.S. Cl. 358/1.15

(57) ABSTRACT

User software provided to a user by a photo developer provides the user with functionality to access and view digital images on a display of the computing device and electronically place orders for photographic prints and the like with the photo developer. Software operative on a centralized server system receives orders from users and search requests for store locations meeting certain proximity criteria. The software calculates and estimated order pick-up time and displays to the user for each store meeting the proximity criteria the estimated order pick-up time along with a distance to the store from the user's location.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### BACKGROUND OF THE INVENTION

1. Field Of The Invention

The present invention is related to the field of digital photography and, in particular, to a system and method for capturing digital images and producing a picture from said digital image.

2. Description Of The Related Art

Recently, the world of photography has experienced an explosion in digital photography. As consumers have become more comfortable with the technology, and as digital cameras have become more powerful to produce clearer and crisper pictures, consumers have increasingly purchased digital cameras and used such cameras for taking pictures both on an amateur and professional level. As a result of this explosion, various services have been proposed to provide a means for the consumer to get their digital pictures developed. One such service permits the photographer to bring their digital media into a photo developer and upload the digital images into a kiosk provided by the photo developer. Once the images are uploaded, the images are transmitted to a photo development system that prints the digital images in a size, color, and style selected by the user. Once the printed pictures are ready, the consumer returns to the photo developer to pick up the prints. Such services, however, are not ideal because the services require the consumer to make two trips to their photo developer each time they have digital images to be developed.

Other services, permit a photographer to access an Internet-based digital image upload system from a remote location, such as their home computer. In such systems the digital images are uploaded either from digital media (e.g., flash memory, CD-ROM, hard drive, etc.) or directly from the photographer's digital camera into the photographer's computer and then transmitted through the Internet to the digital image capture system. Pictures are then printed from the digital images and mailed to the address of the photographer's choice. Images may also be forwarded to additional addresses as gifts or provided as an Internet accessible digital photo album for viewing by selected family members or friends. These services, however, are not ideal because they require the photographer to pay for the shipping of their photographs and are also typically more expensive on a per picture basis. Moreover, these systems require an internet connection and a certain level of sophistication in using the Internet. Further, users of such systems must be confident in the transmission of credit card data via the Internet.

### SUMMARY OF THE INVENTION

Using user software provided by a photo-developer, the user can select one or more of the digital images to incorporate into an order for photo prints. Once the digital images are selected, the user can select one or more printing options. After the printing options are selected, the software application creates an order file. The user then selects between an in-store pick-up option and a mail delivery option. If the in-store pick-up option is selected, the user is presented with functionality to locate the store located in close proximity to the user's home address or other address, as applicable. If multiple stores are within a selected distance, then the user may select a preferred one of the multiple stores. If, however, the mail delivery option is selected, then the user's pre-stored delivery address is retrieved (as is described further below) or the user is presented with an address entry form.

At this point, the user software presents the user with a form to enter payment information, or, in a manner similar to retrieval of the user's delivery address, retrieves the user's payment information (as is described further below). The user software then causes the computer to communicatively connect to a remote photo developer server system. The order file, along with the delivery and payment information, is transmitted to the photo developer service system. Once the transmission is complete the communications connection is terminated. The digital images that are transmitted with the order file are processed and printed prints in a manner known in the art. Upon completion of the printing process, the prints are either made available for pick-up or mailed to the user according to the user's desired delivery method.

In accordance with an embodiment of the present invention, a method for processing digital images generally comprises: providing software operable on a computer to a user, the order being generated by the software on the computer; receiving from the computer an order to print photographs; providing to the user via the computer a choice to have the photographs delivered by mail or held for pick-up at a store; receiving from the computer a delivery selection; transmitting to the computer product information based on the order to print photographs and the delivery selection; receiving from the computer a product selection; receiving from the computer one or more digital images selected by the user for printing; processing the digital images in accordance with the product selection; and making photographs available to the user in accordance with the delivery selection.

In one embodiment, the user is provided with a computer readable medium, such as a CD-ROM, that comprises application code operable on a computer for implementing the following procedures: prompting a user to select one or more digital images from a storage device; creating an order for photographic prints based on the user's selection of the one or more digital images; displaying information retrieved from a remote server system for one or more products based on the order; prompting the user to select from the one or more products displayed; prompting the user to upload the selected one or more digital images; and providing an order check out procedure to complete the order.

Additionally, a method of calculating an order pick-up time for an order for processing one or more digital images comprises: receiving the order for processing the digital images, calculating an order completion time, comparing the order completion time to a minimum default time, setting a client wait time based on the greater of the order completion time and the minimum default time, retrieving a store delay time, comparing a sum of the order completion time and the store delay time to the minimum default time, setting the order pick-up time to the client wait time if the sum of the order completion time and the store delay time is equal to or less than the minimum default time, and setting the order pick-up time to a sum of the store delay time and the client wait time if the sum of the order completion time and the store delay time is greater than the minimum default time.

Additional features and advantages of the system are described further below.

### BRIEF DESCRIPTION OF THE DRAWINGS

FIG. 1 is a schematic block diagram of the system architecture of a centralized image-processing system in accordance with an illustrative embodiment of the present invention;

FIGS. 2a through 2b depict an illustrative order flow for creating orders using user software on a user computer;

FIG. 3 is a flow diagram depicting an illustrative flow for processing images using a centralized photo processing server;

FIGS. 4a and 4b are flow diagrams depicting illustrative process flows for ingesting and packing orders;

FIGS. 5-10 are screen shots depicting exemplary graphical user interfaces of various features of user software for use with the photo-processing system;

FIG. 11 is a screen shot of an alternate embodiment of the user software for use with the photo-processing system;

FIGS. 12a and 12b are flow diagrams depicting illustrative process flows for calculating and displaying an estimated pickup time for the order; and

FIG. 13 is a description of a lab delay file for use with an alternate embodiment of the photo-processing system.

### DETAILED DESCRIPTION OF THE EMBODIMENTS

In an embodiment of the invention, a user interacts with a software application operative on a computing device. The computing device is capable of communication with one or more servers/databases of centralized system, which in turn is capable of communication with one or more photo developer systems.

The user software provides the user with functionality to access and view digital images on a display of the computing device and electronically place orders for photographic prints with a photo developer. Additionally, the photo images can be printed on products such as compact discs, t-shirts, mugs, and other novelty items. In the present embodiment, the user software generates an order file, which is transmitted via a network (such as the Internet) to a server system of the photo developer. The order file created at the user's computer may either contain the digital images selected by the user for printing or a path to the selected digital images on the user's computer or digital media device. Prints are made by the photo developer in a manner known to persons of ordinary skill in the art.

System Architecture

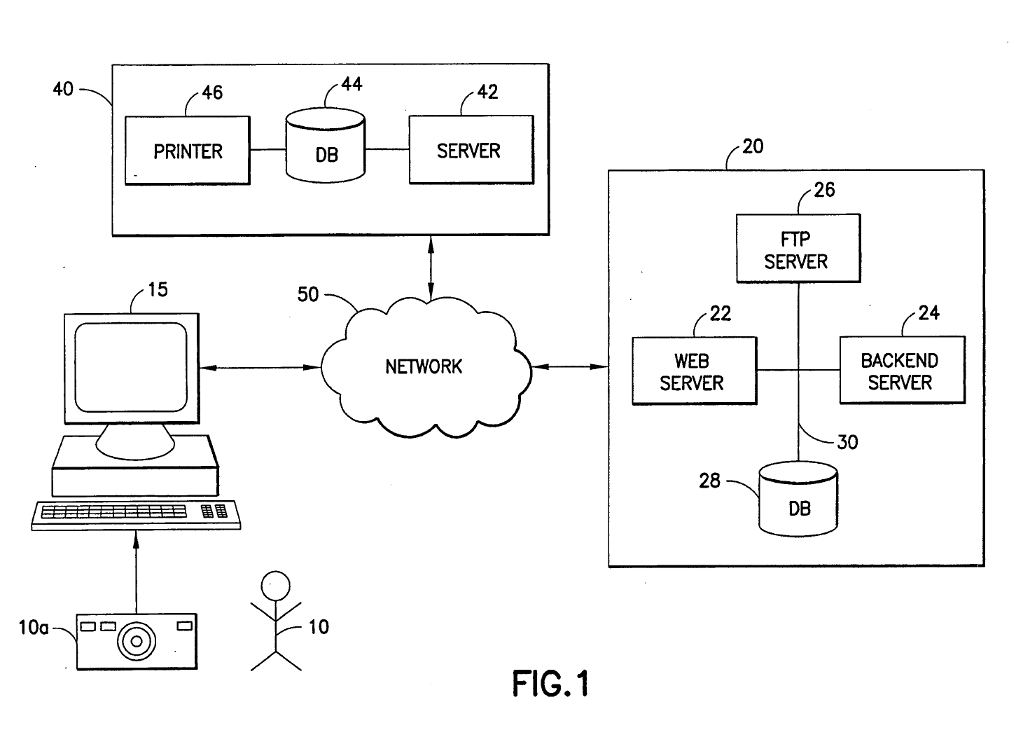

In the embodiment being described, as shown in FIG. 1, a user/photographer 10 uses a digital camera 10a or image scanner to capture digital images. Digital images may also be retrieved from a data storage device, such as, for example, a hard drive, flash media, CD-ROM, DVD, and the like. Such devices may connected to a computer device 15 in ways know in the art, such as, for example, by using a Universal Serial Bus (USB), IEEE 1394 (Fire Wire), and parallel or serial cables to name a few.

The user's computer device 15 is preferably a personal computer of either the desktop or laptop variety having sufficient processing power and communication capabilities to permit it to run the user software application and transmit order and image data to the photo developer's server system. An exemplary computer for use with the present invention would be an IBM-compatible computer having a 3.0 gigahertz processor and including, but not limited to the following components: an 80 gigabyte hard drive, a USB and/or IEEE 1394 port, a CD-ROM and/or DVD drive, a flash memory reader, a display (either CRT or LCD based), a modem and/or Ethernet capability. Of course, one skilled in the art will recognize that the above list of components need not be present on all computers used in connection with the present invention and that different computers with different processing power and components could be used. For example, a user that accesses digital images from a digital camera using a USB cable need not have a computer equipped with the IEEE 1394 port or a flash memory reader.

A centralized system 20 for receiving user orders for photo prints and digital images generally includes one or more web, backend, and FTP servers 22, 24, 26 interconnected with one or more database systems 28 on a network 30. The network 30 may either be a local area network (LAN) or a wide area network (WAN). Similarly, a store server system 40 generally includes one or more servers 42 and database systems 44 operative on a network. The network may either be a local area network (LAN) or a wide area network (WAN). The store server system 40 also includes a printing device 46 for printing the user's selected digital images. An exemplary printing device is Fuji Photo Film's Frontier 570 Digital Lab System. The centralized image processing system 30 is capable of communication with both the user computer 15 and the store server system 40 via a public network 50.

Although not depicted in the figures, the server systems described herein generally include such art recognized components as are ordinarily found in server systems, including but not limited to RAM, ROM, clocks, hardware drivers, and the like. The servers are may be configured using the Windows® NT/2000, UNIX or Sun Solaris operating systems, although one skilled in the art will recognize that the particular configuration of the servers is not critical to the present invention. It should also be noted that although the embodiments described herein describe use of servers and databases in functional terms, such embodiments could be implemented by storing the software or programming that operates the described functions on a single server or any combination of multiple servers as a matter of design choice so long as the functionality described herein is performed. Persons skilled in the art will further recognize that because multiple users may be accessing such servers and databases at any given time it is preferable to utilize multiple servers and databases, which may be used separately or in tandem to support the systems traffic and processing, such as, by way of non-limiting example, a round-robin configuration utilizing multiple server systems.

The phrase “capable of communication with” refers generally to the capability of the user's computer 15 and the store server system 40 to transmit data and messages to one another via any communication network 50, including but not limited to a network using a data packet transfer protocol (such as the Transmission Control Protocol/Internet Protocol (“TCP/IP”), User Datagram Protocol/Internet Protocol (“UDP/IP”)), a plain old telephone system (“POTS”), a cellular telephone system (such as the Advance Mobile Phone Service (“AMPS”)), or a digital communication system (such as GSM, TDMA, or CDMA).

User Software

In the embodiment being described, the user software is provided to users on a CD-ROM. In a preferred scenario, a user will utilize a photo development kiosk made available at a store site to deliver digital images to the photo developer. The kiosk is more times than not located within the photo developer's store. Persons of ordinary skill will recognize that the photo developer may be a large department type store, such as Wal-Mart, K-Mart, Sears, and the like. When the user's photos are developed, the user returns to the photo developer's store to retrieve the prints. At this time, in addition to the prints, the user is provided a CD-ROM having both the user's images and the user software stored thereon. In other embodiments, the user software can be provided to users through the direct mailing of CD-ROMs or Internet download.

The user software may be programmed in any programming language compatible with common operating systems in use, such as, for example, Microsoft Windows 95, 98, NT, 2000, ME, XP or Apple's Mac OS X. Preferably, the user software is programmed using an object oriented programming language, such as, for example, C++, Java, Visual Basic, and the like.

In the embodiment in which the user software is provided to a user on a CD-ROM, the user software is preferably designed to operate in a manner that does not require the user to install the software on a computer. Instead, the user software may be accessed and run directly from the provided CD-ROM. This feature is advantageous because it reduces the need for user's to be computer savvy and, thus enables user's of all computer skill levels to enjoy the ability of accessing, editing, uploaded and ordering prints from their homes or offices. In another alternative embodiment, the user software can be downloaded from a remote site and automatically installed on the user's computer 15.

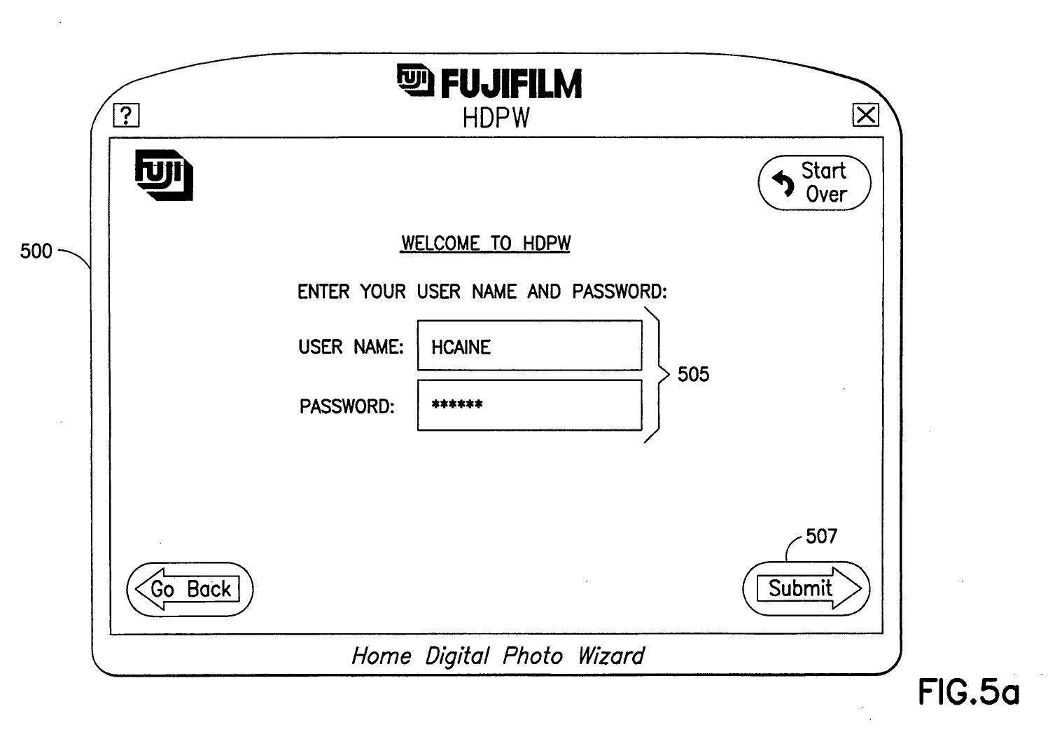

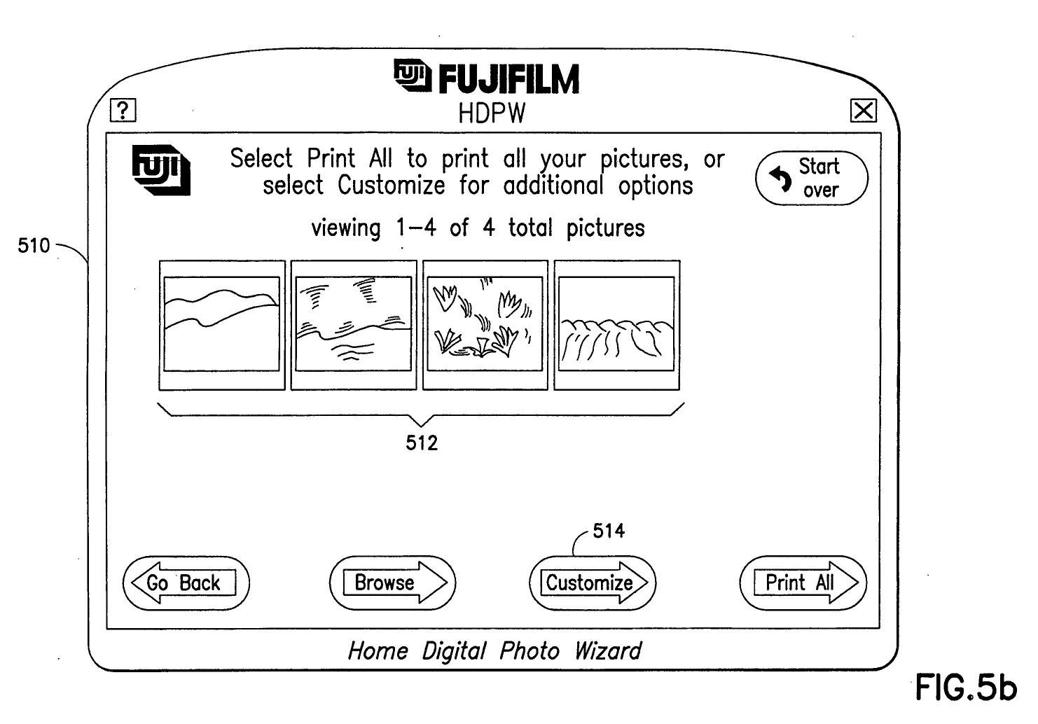

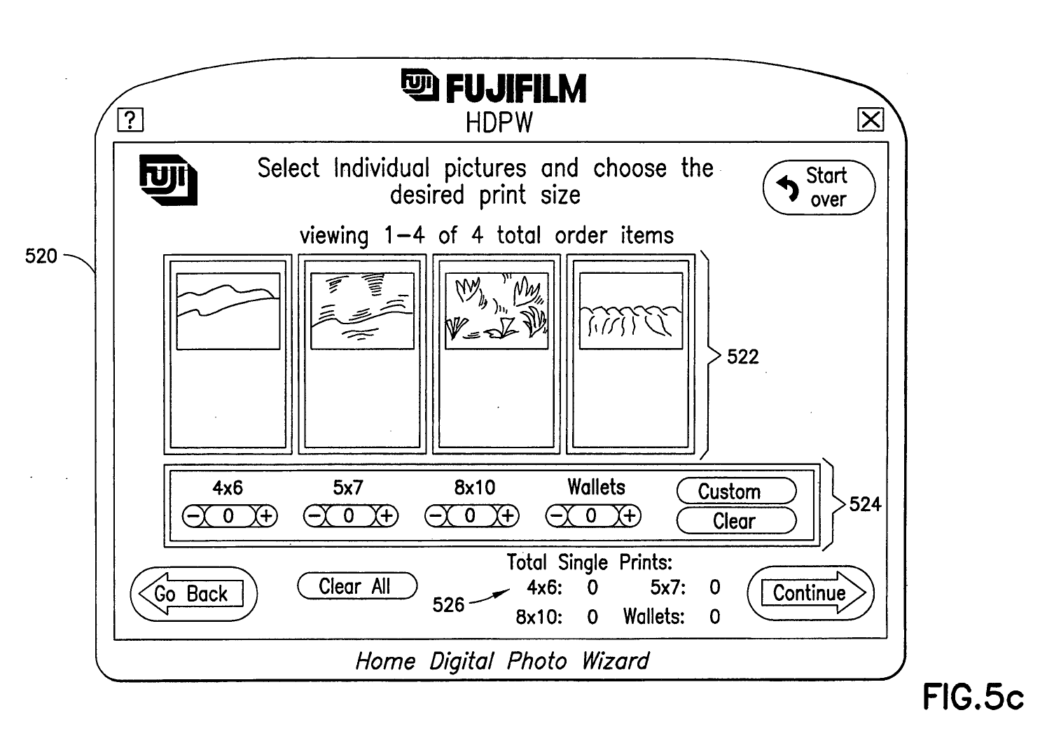

In the embodiment being described, and with reference to FIGS. 5-11, the user software provides graphical user interfaces (GUI) through which the user can perform functions related to the preparation and upload of a photo development order. The GUIs shown in the Figures are illustrative only and are not to be construed to limit the scope of the present invention. The features provided on the GUIs shown in FIGS. 5-11 will be described in greater detail below.

Application Programming Interface (API)

The user software is capable of creating orders for photo prints, transmitting the order and digital images, and communicating other data and information between the user's computer and the photo developer's server system. In a preferred embodiment of the invention, the user software is configured using an API that permits the transmission of data and information between the user's computer and the photo developer's server system. The user software preferably communicates with the photo developers server system using an API such as the Simple Object Access Protocol (SOAP), an Extensible Mark-up Language (XML)-based messaging protocol, which can encode information in web service request and response messages before transmitting them over a network.

In the present embodiment, the SOAP connection is over HTTP, which operates via a TCP/IP socket using standard internet implementations. However, persons of skill in the art will recognize that a direct socket protocol may be implemented using a compatible data format. Image data is preferably transferred using the File Transfer Protocol (FTP), and images may contain additional metadata for things like color and crop parameters. The SOAP API, for example, is used for product, order and account information, and prepares the photo developer servers for an upload of the image data. During and after an upload, the API as used to manage the upload process and communicate order status. The API may also be used to communicate image file metadata, such as color modifications and/or cropping parameters. Various preferred aspects of the API will now be described in connection with a typical photo ordering process.

Upon launch of the user software, as shown in FIG. 5a, the user is presented with a login interface 500 which provides input fields 505 for the user to input a login and password. The login may be any randomly chosen alphanumeric code or the user's e-mail address. The password may be any alphanumeric code chosen by the user. When submitted by the user (in the example shown in FIG. 5a, by clicking a submit button 507), the login information is transmitted by the user software through the communications network to the photo developer's server system. The server system then looks up the login information in the account database to determine whether the login information is correct. If the login information is correct, then the server system sends a message back to the user software that the login is a success. If, however, the login information is incorrect then a “fail” message is sent to the user software and the user is prompted to reenter the login information. Once the user is successfully logged in to the system, the user can begin to access digital images and create photo orders.

In the present embodiment, the user commences order creation functionality using a create order button, although persons of skill will recognize that the order creation functionality can be commenced in many different manners such as by automatically starting an order upon a successful login. At this point, the “Initialize Order” function is called and the server system creates a unique order identifier, which is transmitted in a message to the user's computer. The user is provided with the ability to access a group of photos and select certain photos to be added to the order. As shown in the preview interface 510 of FIG. 5b, thumbnails 512 of the accessed digital images are preferably displayed in rows and columns to simplify the selection process. In a preferred embodiment, the user software is further configured to allow users to edit the digital images by providing one or more digital editing tools, such as, for example, cropping, rotation, sizing, color, hue, contrast and other tools. In the present embodiment, shown in FIG. 5b, images are selected by clicking on the thumbnail. By selecting one or more images, and further selecting a “customize” button 514, the user can access an editing interface 530, such as shown in FIG. 5d. After customization and selection of images to print, the user is presented with an interface 520, as shown in FIG. 5c, to select the number and size of images to be printed. The image thumbnails 522 are displayed as are icons 524 for selecting the size and number of prints. A summary window 526 is also preferably displayed. Upon selection, the image path for the selected image is added to an order file designated using the unique order ID.

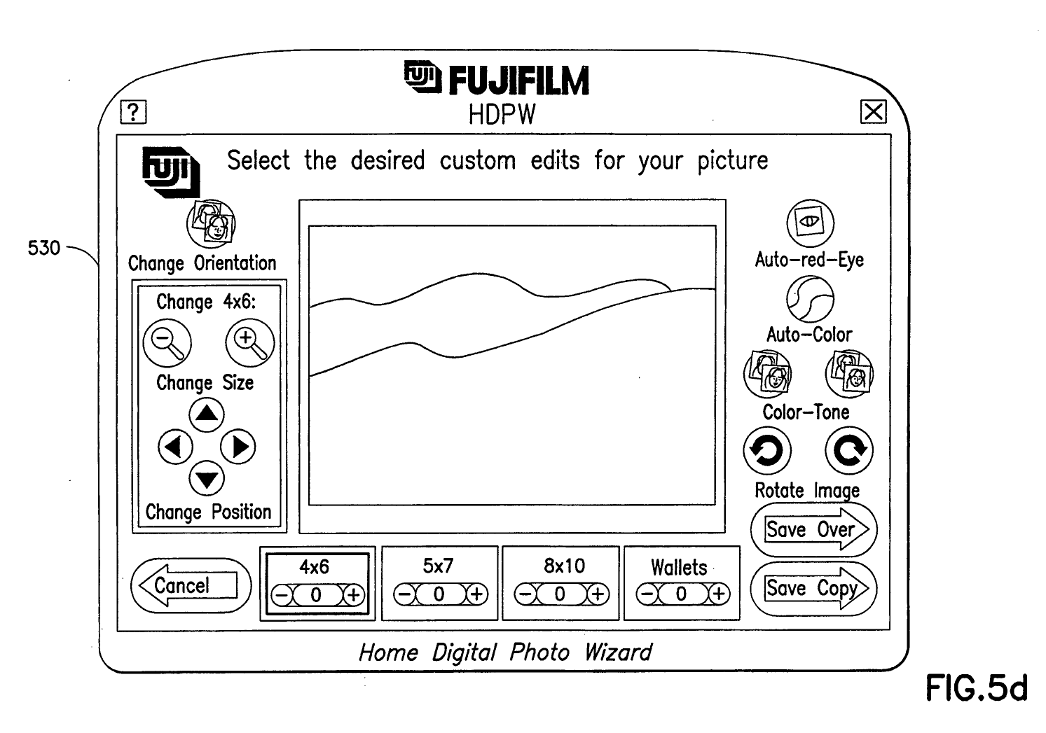

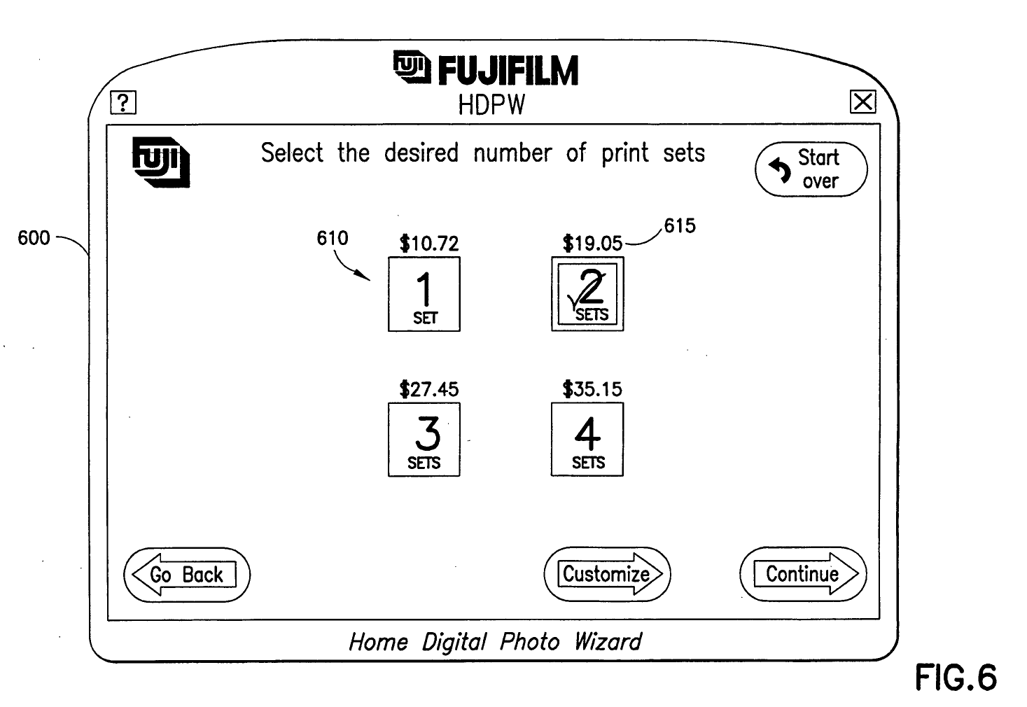

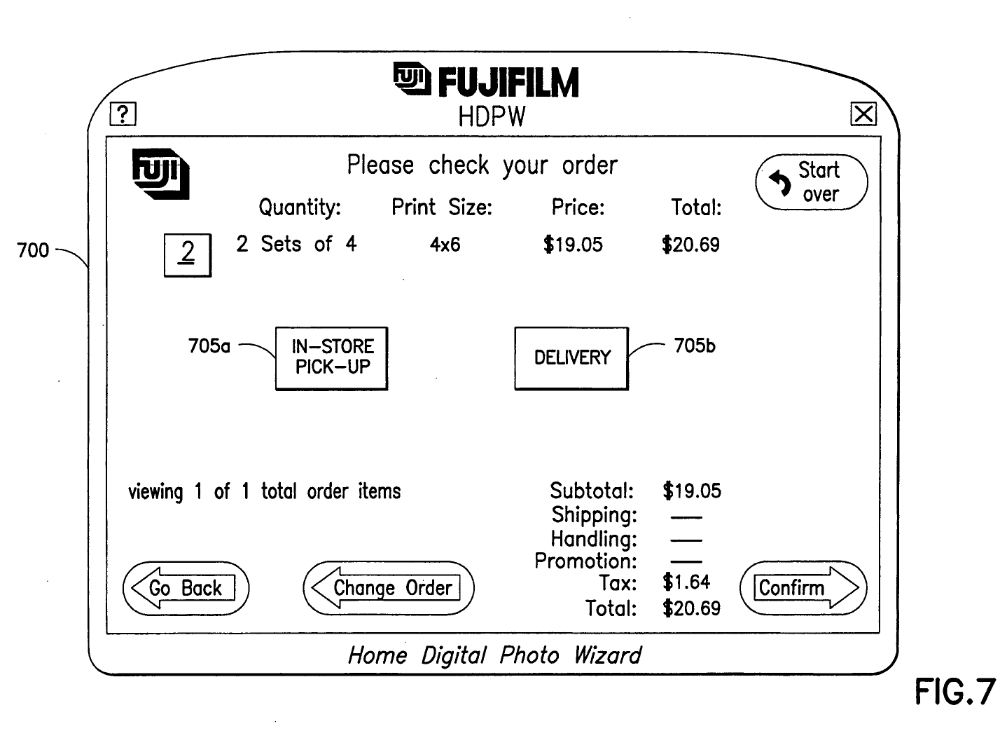

Once the digital images are selected, a GetProductCatalog message is transmitted to the backend server. The “GetProductCatalog” message includes a vendor ID and triggers a call to the database to return order information. The order information preferably includes item prices, shipping price, handling price, promotional prices, and tax amount. The vendor ID indicates to the backend server which prices/order information to return based on a particular vendor. For instance, Wal-Mart and another photo developers/vendors may have different prices, price packages, or promotions at any given time. The GetProductCatalog message returns various product information, such as item prices, shipping prices, handling prices, promotional prices, tax, and the total price for a particular selection. As is shown in print selection interface 600 of FIG. 6, the GetProductCatalog functionality has returned four options 610 to the user based on the user's image selections. Depending on which of the options the user selects, a different price 615 is shown. Once the user makes a selection, an order summary interface 700 is displayed. The order summary interface 700 of FIG. 7 allows the user to select in-store pick-up or delivery of the order using buttons 705a and 705b.

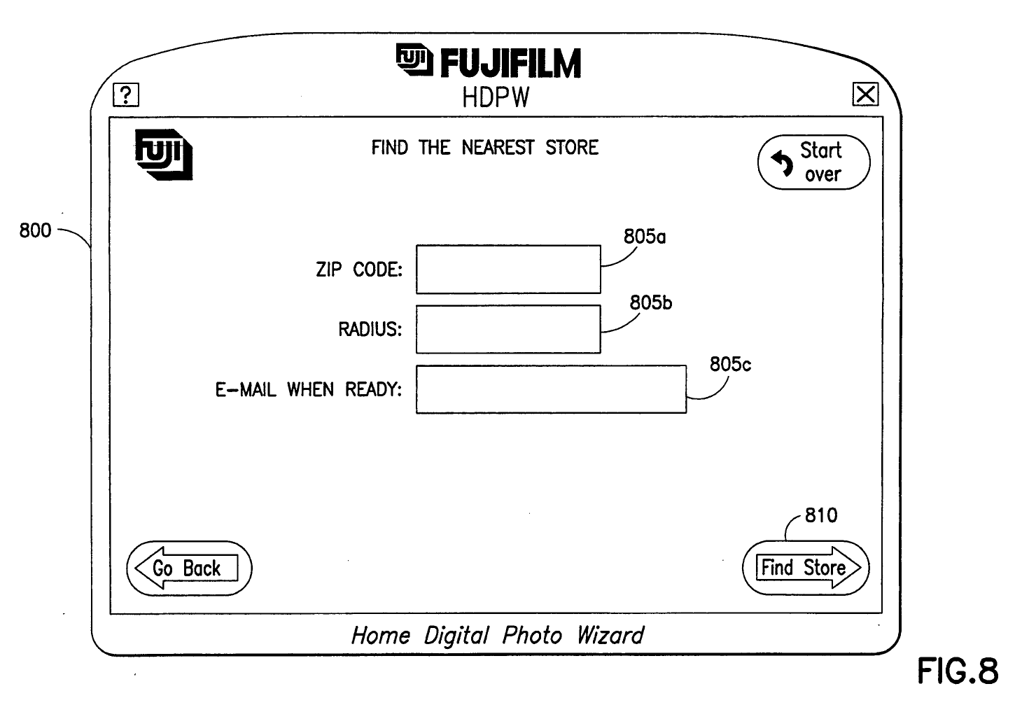

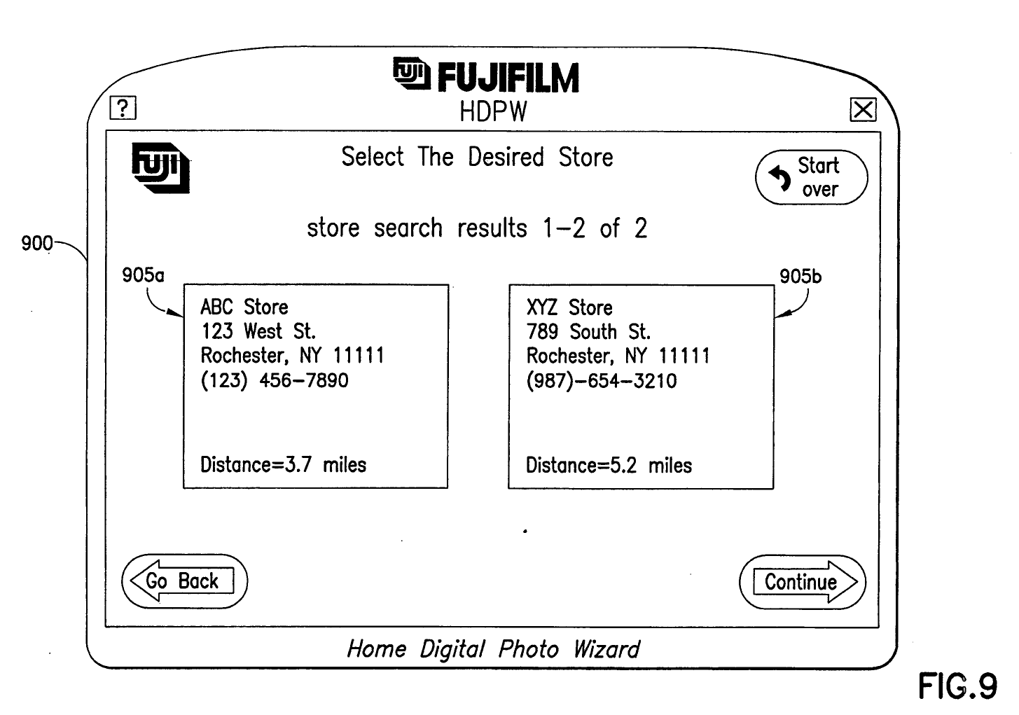

Assuming the user selects the store pick-up delivery method, the user is presented with a store locator interface 800, such as is shown in FIG. 8, to locate the nearest store. The store locator interface 800 preferably contains input fields 805a, 805b, 805c to permit the user, for example, to enter his/her zip code, a preferred radius, and a notification e-mail. When the “Find Store” button 810 is pressed, this information is transmitted to the server system and various stores that match the user's criteria are returned to the user software. As is shown in the store selector interface 900 of FIG. 9, one or more stores locations 905a, 905b are displayed and the user is given an opportunity to select one of the displayed stores.

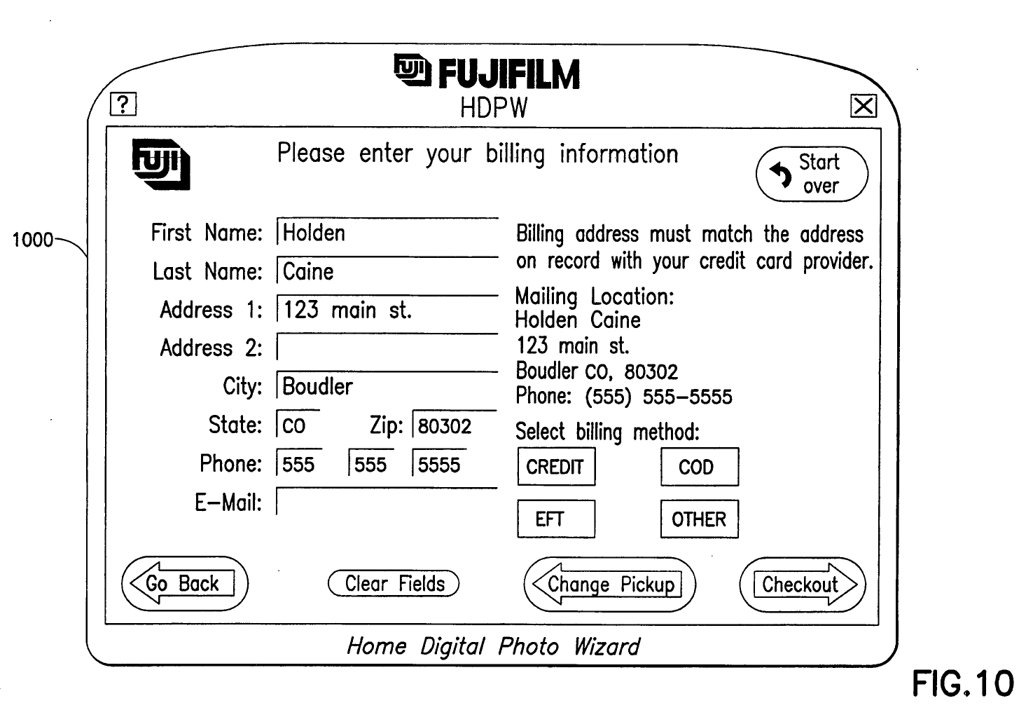

Once a store is selected, a check-out procedure is commenced. In the present embodiment, the user may be provided with a order summary interface (not shown), through which the user can review the order and either confirm the order as is or use a change order functionality. Assuming that the user does not wish to change the order, the user is then presented with a billing information interface 1000, as shown in FIG. 10, through which the user can enter credit/debit card information to pay for the order. Once the user has finalized the payment and billing address information, and has submitted such information to the backend server, the backend server performs a credit/debit card payment authorization. If the authorization fails, then a fail message is sent back to the user software and the user is asked to re-enter the billing information. If the authorization is a success then the image upload process begins. Once each of the images is successfully uploaded to the backend server, a work confirmation screen is shown to the user and may be printed by the user.

Photo Order Process Flow

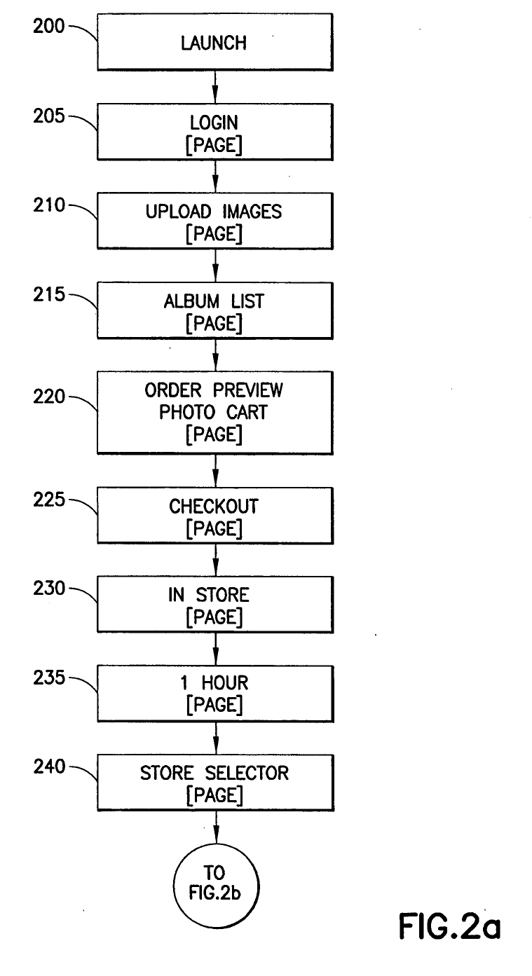

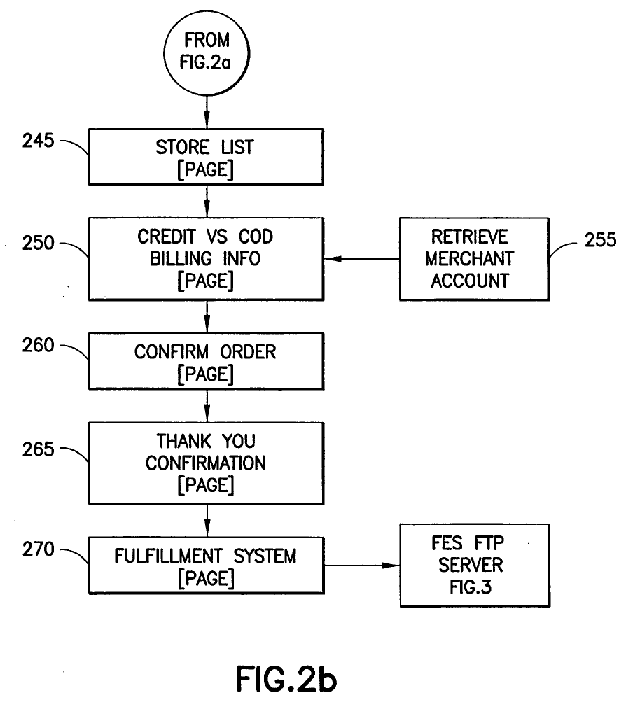

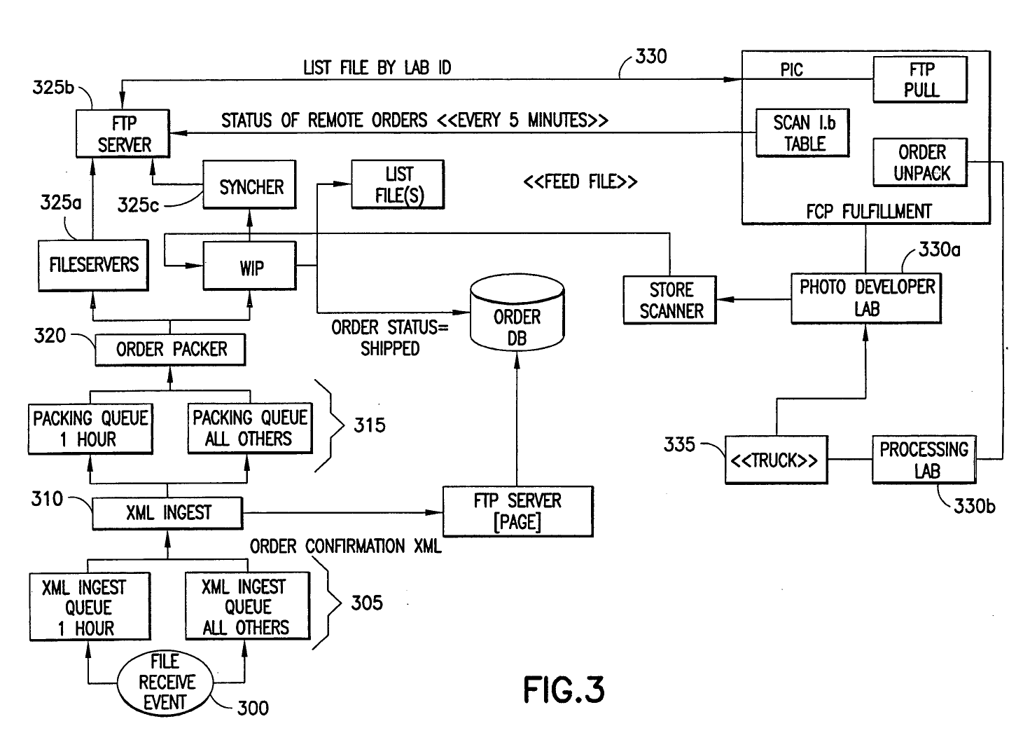

With reference to FIGS. 2a-2b, the user software is launched in step 200. It should be noted that the user software can be used either when connected to the centralized server system 20 via a network 50, such as the Internet, or offline. In the embodiment being described, the user software is utilized in an online or connected environment. In step 205, the user logs-in through a login page 500, as described above in connection with FIG. 5a. In step 210, selected images are uploaded to the server system 20. An album list page 510 (FIG. 5b) is generated by the user software using information from the server system 20 in step 215. The albums are preferably represented by representative thumbnails 512 as displayed in interface 510 of FIG. 5b. A customization button 514 is provided to permit the user to commence customization functionality as described further below. As shown in FIG. 5c, if the user desires to customize the order or the images in his/her albums, a customization interface 520 is generated. The customization interface preferably includes a display of thumbnail images 522, a print size selection toolbar 524, and a summary frame 526. Next, as shown in FIG. 5d, an image editing interface 530 may be accessed by the user. Using image editing functionality provided by the user software, the user can correct red-eye, adjust coloration and tone, rotate or crop the image, and make other such adjustments as may be desirable.

Next, in step 220, the user is presented with a print selection interface 600, as shown in FIG. 6. The print selection interface 600 displays various products 610 available to the user and the corresponding prices 615. In step 225, if the order is accepted in step 220, the user is presented with a checkout page 700 as shown in FIG. 7. In step 230, the user selects either in-store pick-up or delivery using, for example, the buttons 705a and 705b in the checkout page interface 700. In the present embodiment, in-store pickup is assumed. After selecting the delivery type, in step 235, the user is prompted to select the order completion time; e.g., 1-hour, 1-day, etc. Because certain large or complex orders may take longer, the server preferably estimates the order completion time based on certain criteria, including but not limited to order size (e.g., the number of images and the number of requested prints), product selection, transmission bandwidth to the store, and the current store order load and printer availability. In a preferred embodiment, communication bandwidth (i.e., bytes/second) is calculated by the production system as it pulls orders from the server. This bandwidth value is sent back to the server and used in the order delivery time calculation that informs the customer of the time when the order will be ready for pick-up. Thus, if 1-hour pick-up is not possible due to the above-mentioned factors, the user will not be offered the choice of 1-hour pick-up in the delivery type selection interface. In step 240, the user software initiates the store selector procedure and is presented with a store selection interfaces 800 and 900, as shown in FIGS. 8 and 9, respectively.

It will be understood that orders created by users can be saved to the user's local hard disk and accessed at a later time to be completed and transmitted to the server. Orders may also be produced off-line, using the most recent product and store information available (or cached) on the user's machine, then transmitted to the server at a later time, once communication is available. If the user creates and order offline, order validation would be performed to update pricing, store location, and other such information once communication is established. Orders may also be saved to removable media, taken by the user to the store, and imported directly into the production system or kiosk to be further edited and produced (to avoid the time required to upload a large number of images).

With reference now to FIG. 2b, in step 245, the user software retrieves a list of stores meeting the user's requirements. An example of such a list is shown in FIG. 9. Next, in step 250, the user is prompted to select a payment method and enter billing information. FIG. 10 depicts an illustrative billing information entry interface 1000. Payment may be made by credit card, cash on delivery (COD), or any other electronic funds transfer method now know or heretofore developed. If the user has a pre-existing merchant account, in step 255, the merchant account information is retrieved from the server system and displayed by the user software. After the payment information is submitted, a confirmation page (step 260) and a thank you page (step 265) may be displayed. At this point, as shown by step 270, the user software communicates with the photo developer's order fulfillment system.

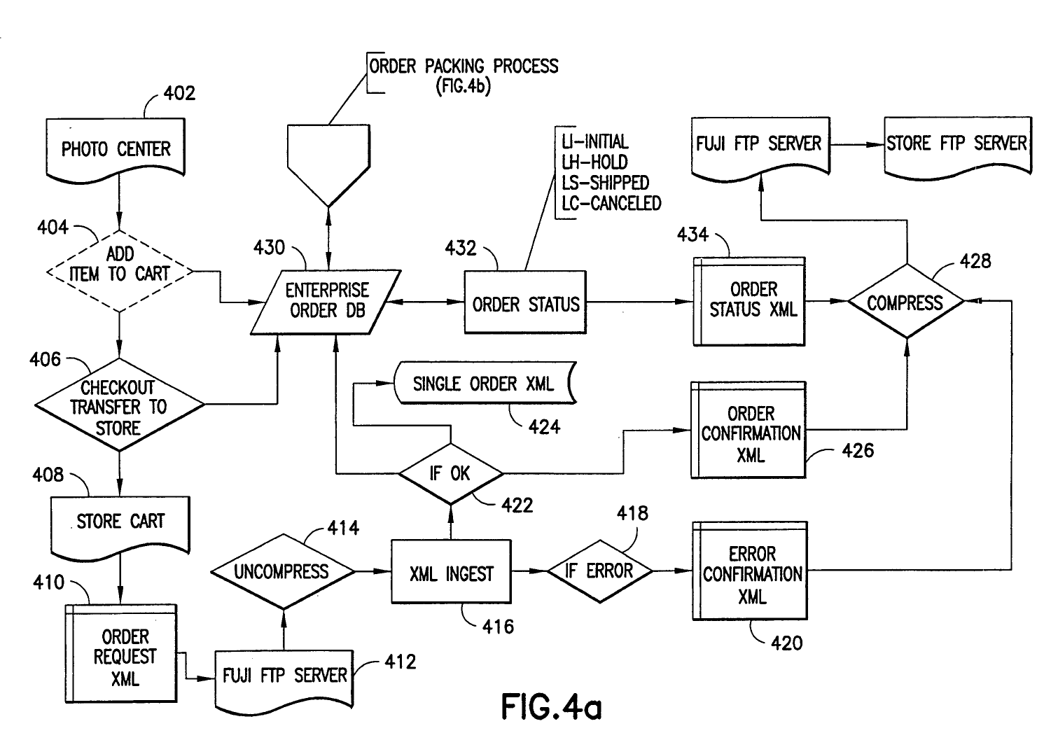

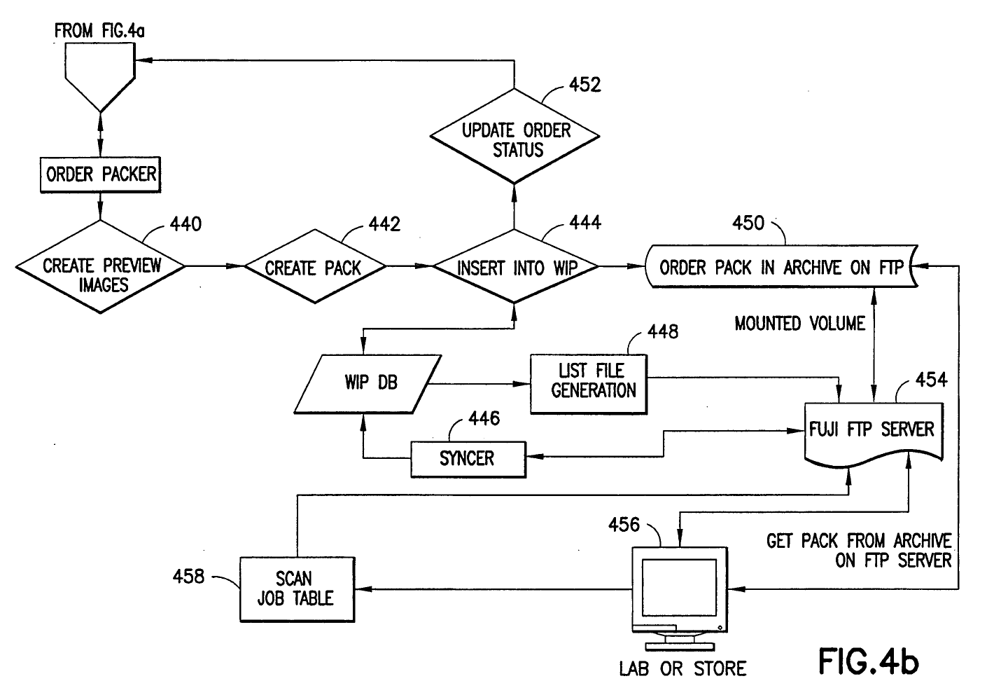

With reference now to FIG. 3, order-related data messages are communicated using SOAP to the FTP server, in step 300. In step, as shown in FIG. 305, the order details are placed into one of two XML Ingest Queues depending on whether 1-hour delivery or some other delivery type is selected by the user. Using a dedicated 1-hour delivery Ingest Queue avoids potential back-ups that could be caused by intermingling the 1-hour delivery orders with other, slower return orders. At this point, in step 310, the XML Ingest procedure is performed. FIGS. 4a and 4b, as discussed in greater detail below, provides further detail of the XML Ingest procedure.

With reference again to FIG. 3, in step 315, the ingested orders are placed into one of two Packing Queues depending on whether 1-hour delivery or some other delivery type is selected by the user. As with the Ingest Queues, using a dedicated 1-hour delivery Packing Queue avoids potential back-ups that could be caused by intermingling the 1-hour delivery orders with other, slower return orders. Orders are then packed in order according to priority in the Packing Queues, in step 320. The order packer functionality collects all of the image files associated with a particular order into an order file that is transmitted to the photo development lab, as discussed below.

In step 325a, a series of file servers transmit the order files to a FTP server that uploads the order file to photo printing system. The status of the orders are updated by a Photo Imaging Controller (PIC). Preferably, the order status is updated every 5 minutes. The status information is passed by the FTP servers to a Syncher, in step 325b, that coordinates messaging with the Order Packer using a Work In Process (WIP) database. In other words, the Syncher can update the WIP database, in step 325c, so that the Order Packer software can determine when the next order file should be packed and transmitted via the file servers and FTP servers. The WIP database also stores information related to the status of completed orders and can provide updates to users via the user software.

In step 330, the order files transmitted to the order fulfillment system or PIC are delivered depending on size to either the photo developer lab at the subject store location (step 330a) or to a high volume processing lab (step 330b), such as the Fuji Color processing lab. If the images are sent to the high volume lab, then after the images are printed they are shipped, in step 335, to the store location where the prints can be picked up by the user.

Turning now to FIGS. 4a and 4b, there is shown an illustrative process flow for ingesting and packing order details received from the user software using the SOAP-type XML. The ingestion process includes steps for checking out orders (steps 402-410), uploading the order information and digital images via the FTP server and ingesting the order details (steps 412-428), monitoring the status of the order (steps 430-434), and packing the orders (FIG. 4b). With reference with FIG. 4b, the order packing process involves gathering all images and order information (e.g., products, quantities, template graphics, shipping/packaging instructions, due-by time, customer information, pricing, special instructions) into one or more files for transmission to the production system. In addition, data is included on the order pack that allows the production system to produce receipts and labels for packaging and (optionally) shipping. Collecting this data into one or more files simplifies the transmission process, as is it more efficient to send a small number of large files, rather than a large number of small files. For large orders, multiple packs may be used to avoid retransmission of the entire order in case of a communication dropout.

Specifically, further to the process shown in FIG. 3, FIG. 4b shows the various steps of an illustrative packing process. According to the illustrative process, order packer software creates thumbnail or preview images of the uploaded digital images (step 440), creates a pack file (step 442), inserts the pack file into the work in process (WIP) database (step 444), which interacts with the Syncer to determine when the next order is ready to be packed (step 446). The WIP database also generates a list file of the packed orders (step 448). Separately, the packed order is archived on the FTP server (step 450) and order status information is updated (step 452). The above-information, including the WIP database information, order list file and actual packed order file are passed to the FTP server (step 454) and on to the lab or store for processing (step 456). The store can use a scanner (step 458) to update order status to show that the order has been filled.

Estimated Pickup Time Determination and Display

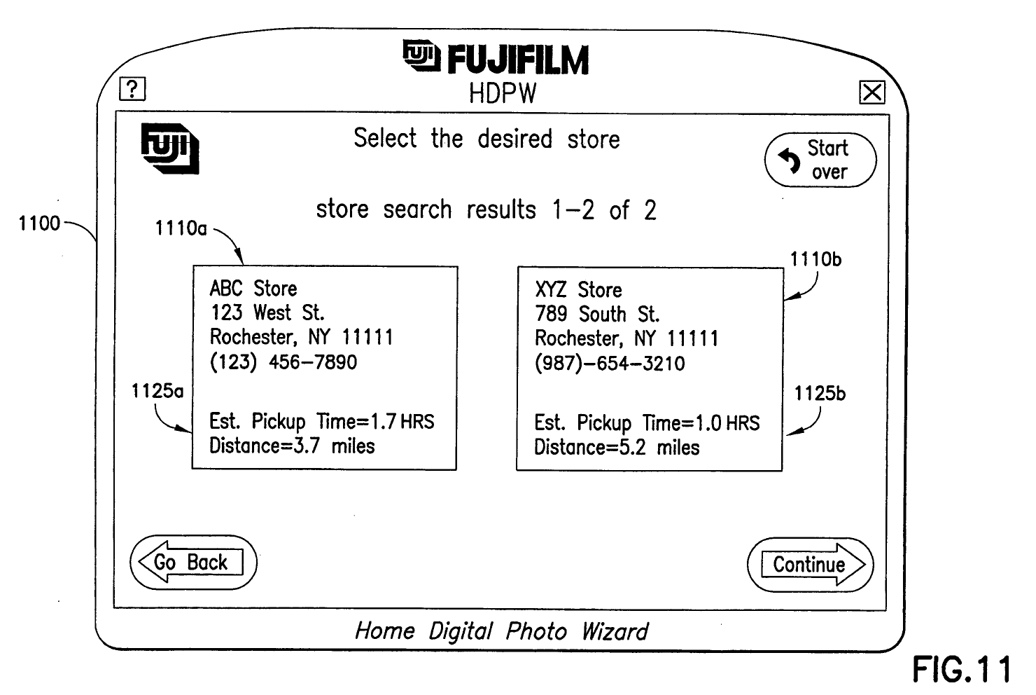

FIG. 11 is a screen shot of an alternate embodiment of the user software. In this alternate embodiment, when the user selects the “find store” button 810 in FIG. 8, an estimated pickup time interface 1100 as shown in FIG. 11 presents the user with a list of stores 1110a, 1110b, etc. to pickup their order based upon a distance from a particular location and an estimated pickup time 1125a, 1125b, etc. to pickup the user's order. It is understood that based upon values submitted by the user, the list may contain zero or more entries.

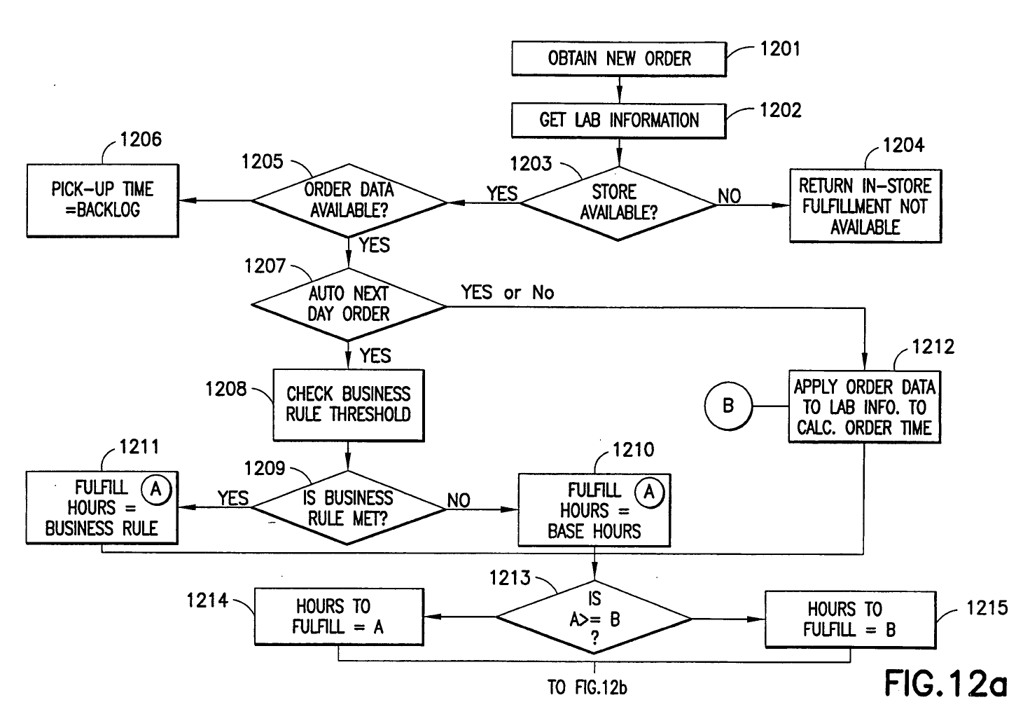

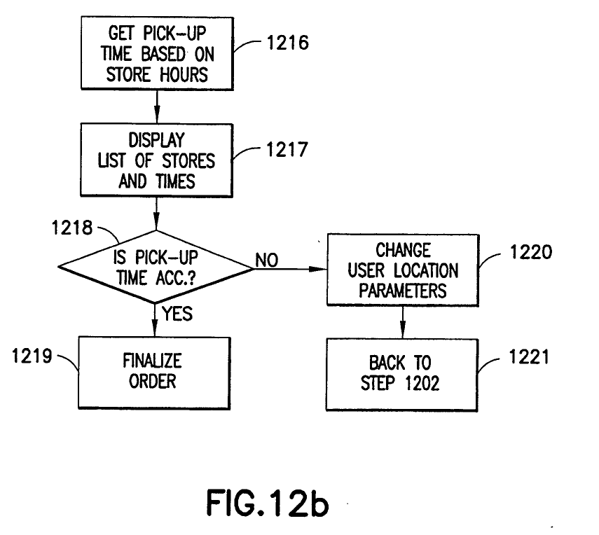

Referring to FIGS. 12a and 12b, there is described flow diagrams depicting illustrative process flows for calculating and displaying an estimated pickup time for the order. The centralize system 20 may further be programmed to allow distributed fulfillment as a managed service. When a vendor site is connected to the centralized system 20 through a network, orders can be transmitted nearly instantaneously after customer checkout and order status is known within minutes of a change. Network throughput can be measured substantially in real-time and remote order queues are monitored with high precision. With the rate of change of variables which affect distributed fulfillment from a central location, a process is required to determine a time when a customer can go to the fulfillment location to pickup their order. The Order Pickup Timestamp process accomplished this goal examining various variables which can affect the production of print orders. In a preferred embodiment of the Order Pickup Timestamp process, business logic is applied to determine a base number of hours that it will take to fulfill an order. When some of the required information is not retrievable based on various business constraints, business rules alleviate the need for having knowledge of such variables. In addition, because a customer cannot be given a pickup time which is outside of the business hours, the final pickup time is preferably calculated based on hours of operation.

In a preferred embodiment, by way of example only, a database contains a data table detailing the length of time for a lab to print all orders currently queued-up for it, the network throughput to the lab, and the availability of the lab based on whether it is connected to the centralized system 20, its hardware is functioning properly, and/or whether the lab is offline for some reason. By way of example, a database preferably includes the following data fields and information:

TABLE I

| Column Name | DataType | Description |
|---|---|---|
| StoreNumber | INTEGER | N/A |
| LabCode | VARCHAR(10) | N/A |
| ClientID | INTEGER | N/A |
| InStorePrintingCapable | TINYINT | 1 \| 0 based on whether store is connected to |
| | | the centralized system 20 |
| LabHardwareDown | TINYINT | 1 \| 0 based on hardware in lab |
| LabOffline | TINYINT | 2 \| 1 \| 0 based on ISD feed of stored on |
| | | modem backup list (value of 2), Store has not |
| | | reported for a threshold amount of time (value of 1) |
| KBPSThroughputToLab | FLOAT | KBPS throughput of last transmission |
| LastComDatetime | DATETIME | Last time data was updated with info from lab |
| NumPrintsPerHour | INT | Number of prints per hour lab is capable of producing |
| NumPrintsInLabQueue | INT | Number of prints in lab that are queued for printing |
| LabPrintBacklogMinutes | INT | Calculated field: Number of minutes the a new |
| | | job will need to wait before it begins printing. |
| | | ((NumPrintsInLabQueue/NumberOfPrintsPerHour) * 60) |
| TransmissionFileSizeKB | INT | KB of files to be transmitted to Lab |
| TransmissionBacklogMinutes | INT | Calculated field: number of minutes to transmit |
| | | queued orders to lab. |
| | | ((TransmisionFileSizeKB/KBPSThroughputToLab)/60) |
| NumPrintsInTransmissionQueue | INT | Number of prints in transmission queue |
| TransmissionPrintMinutes | INT | Calculated field: number minutes to print items |
| | | in transmission queue. |
| | | ((NumPrintsInTransmissionQueue/NumPrintsPerHour) * 60) |
| TotalPrintDelayMinutes | INT | Calculated field: LabPrintBacklogMinutes + |
| | | TransmissionBacklogMinutes + TransmissionPrintMinutes |
| LastUpdateDateTime | DATETIME | Last time that the data in the record was updated |
| AnticipatedServiceRestart | DATETIME | Anticipated Date and time when the printing services |
| | | are to be restored when the LabHardwareDown, or |
| | | LabOffline indicators are non zero. This can be used |
| | | as a starting point for determining pickup time |
| | | when the lab is not available. |

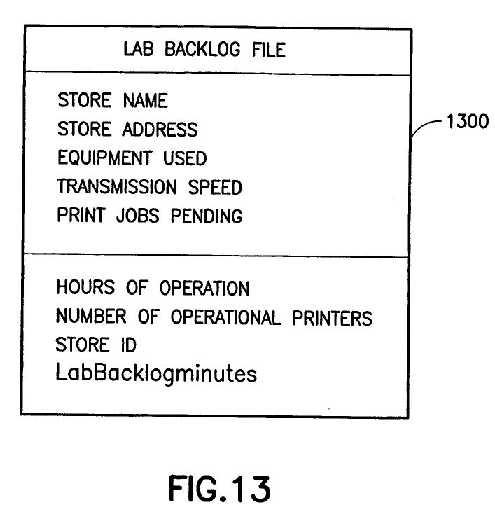

In step 1201, the centralized system 20 receives the order as described above. The order may include, among other items, the total number of photographs, the size of each photograph, and a link to the location of each photograph either internal to the order file or stored locally on the user's machine 15. Once the order is obtained, in step 1202, the system 20 retrieves the lab information including “NumPrintsPerHour”, “NumPringsInLabQueue”, and “LabPrint BacklogMinutes”. Using the retrieved lab information in step 1203, a determination as to whether the lab is available for in-store fulfillment is made. If the store is not available then in step 1204 a message indicating that in-store fulfillment is not available is returned. If fulfillment is available, a determination is made as to whether the order data has been gathered, in step 1205. Next, if no order data has been gathered, in step 1206, the pick-up time is returned based on the “LabPrintBackLogMinutes” value. As described more fully below with reference to FIG. 13, the lab backlog value may take into account, among other things, the amount of available printers, the amount of operational printers and the level of printing materials in stock to fulfill orders. In addition, the store delay time may include an additional delay factor based upon the bandwidth of the telecommunications between the main server and the store. For example, if the store is having trouble with its telecommunication line, the store delay time may be infinite. Likewise, a store connected via a satellite relay as opposed to a cable connection may incur additional delay based upon the available download bandwidth. A store may also include additional delay time that may be selectively controlled by each store, for example, the amount of employees working in that department for a particular period of time or even the store hours of operation, i.e. when the store is closed, the store delay time is infinite. It is understood that a preselected value would indicate an indefinite delay time. In an alternate embodiment, the store delay time may be predetermined by each store and transmitted to the central system. In addition, the store delay time may be calculated for all stores or just the stores within a particular radius of the user's location.

Referring back to FIG. 12a, if order data has been gathered, then a determination is made as to whether the order is an automatic next day order, in step 1207. In step 1208, the business rule threshold for the store is checked. The business rule may indicate that the store can or cannot handle certain orders or that a base number of hours for orders exists. For example, if the order requests the printing of two small pictures, the order completion time may be on the order of several minutes while a default time may be on the order of an hour or so. This default time may take into account nuances for each store or the system wherein while printing a small order may require only several minutes, the operation of the system including the servers, to fulfill the order may require additional time. It is understood that the default time can be set to any time period or changed if needed.

In step 1209, it is determined whether the business rule is met. If the business rule is met then the fulfill hours “A” is set to the business rule value in step 1211. In step 1210, if the business rule is not met, then the fulfill hours “A” is set to the base hours value (e.g., 1-hour). In parallel, in step 1212, the order data is applied to the lab information to calculate an order time (shown as “B” in FIG. 12a). Using information contained in the order file, the centralized system 20, thus determines a standard time to print the pictures based upon a combination of the number and size of the files, as well as factoring in potential delay due to the user's unique photo customizations requested for some or all of the files. The calculate order completion time programming also preferably takes into account a standard minimum set-up time for each store assuming that a minimum number of digital photo printers are available and operational and assuming that the connected store is communicating with the centralized system 20 over a minimum bandwidth Internet connection. By way of example, in the preferred embodiment being described the estimated order completion time equals the “TotalPrintDelayMinutes” or “LabPrintBacklogMinutes” plus “TransmissionBacklogMinutes” plus “TransmissionPrintMinutes”. Referral to Table I above will indicate the additional variables included in the “TotalPrintDelayMinutes” calculation.

In step 1213, the centralized system 20 then determines whether the fulfill time “A” based on the business rule is greater than or equal to the calculated order completion time “B”. If the fulfill time A is greater than or equal to the order completion time then in step 1214, the centralized system 20 sets the hours to fulfill to the fulfill time A value. If not, in step 1215, the centralized system 20 sets the fulfill order value to the order completion time value B.

Continuing with reference to FIG. 12b, pick-up times for the selected stores are retrieved based on the store hours, in step 1216. Thus, if the fulfill time is 10 hours, then the pick-up time will, for example, roll to the next day the store is open. In step 1217, a list of store search result locations 1110a, 1110b and corresponding estimated pickup times 1125a, 1125b is displayed. It is understood that this process may be performed for any number of the stores displayed to the user. In step 1218, the user is presented with a choice whether or not the estimated pickup time is acceptable. If the estimated pick-up time is acceptable the order is finalized in step 1219, as described above. If not, the user is asked to reenter values such as zip code to limit the pickup location in step 1220, as described with reference to FIG. 8. It is understood that the data entered by the user could be any information useful for determining the location of a store to pick up the order, for example, the store's name, travel time to a store, etc. The process then continues back to step 1221 to recalculate pick-up times. For example, if the estimated pickup time is over 2 hours for 3 stores located within 2 miles of the users location, the user may expand the radius that they are willing to travel to 10 miles and the corresponding number of stores that offer the present system increase thereby increasing the possibility that a particular store may have a more acceptable estimated pickup time.

In an alternate embodiment, the order file may contain a store ID field which contains a unique value for a particular participating photo processing center. Step 1202 may therefore obtain the store ID value which corresponds to a user's preferred location to pickup the order regardless of any estimated pickup time. Similarly, if the store ID is left blank, the system may then determine the nearest location of a store capable of developing and printer digital photos based upon the user's zip code or similar entered limiting data. It is understood that the estimated pickup times, or any of the times that are used in its calculation may be rounded up or down to a set period of time, for example, in five minute increments or increments of a half an hour or hour.

In another alternate embodiment, the step 1202 of obtaining the lab information (including backlog time) may either be performed by the central server 20 or received from the individual store. For example, a lab delay file 1300 as described in FIG. 13 may be sent to server 20 when the store delay time is required. The lab delay file 1300 must include either a store ID field or a store name field and a store address field for identification purposes. If the store determines the store delay time, then the store enters a value in a calculated store delay field. If the server 20 determines the store delay time, then one or more additional fields may contain values. For example, the lab delay file 1300 may also include an equipment used field which may describe the equipment used to process and print the digital photos as well as the quantity of equipment available. A transmission speed field indicating the bit rate for transferring data between the particular store and the central system 20. A print job's pending field including data of the current number of print jobs pending up to the time of the creation of the lab delay file. In addition, a store hours of operations field includes the days of the week the store is open and the hours of the given day wherein digital photos may be printed. Lastly, a number of operational printer field may contain the number of printers capable of printing digital photos. Once lab delay file 1300 is generated, file 1300 may be sent to central server 20 in order to determine the store delay time for this particular store location. In an alternate embodiment, the lab delay file may be maintained at the store location at a pathname known to the central server wherein, the central server may access the delay file 1300 at any particular time. In addition, the store may update file 1300 at any given time interval, for example, every 30 seconds. In another embodiment, the central server 20 may maintain the lab delay file 1300 locally and update it with information requested of each store location. The requests could be performed at routine intervals to maintain current store delay times.

In another embodiment, the central server 20 may assign additional periods of delay to any given store in an attempt to set a priority based upon a favored store location. For example, all but a few stores or vendors may include a default store delay time which is added to the store delay time so as to direct more traffic to a particular store. In addition, the system may make a threshold determination wherein stores with equal delay times or delay times that differ less than a particular margin, favor one particular store.

Thus, while there have been shown and described fundamental novel features of the invention as applied to the exemplary embodiments thereof, it will be understood that omissions and substitutions and changes in the form and details of the disclosed invention may be made by those skilled in the art without departing from the spirit of the invention. It is the intention, therefore, to be limited only as indicated by the scope of the claims appended hereto.

1. A method of calculating an order pick-up time for an order for processing one or more digital images, the method comprising:
receiving the order for processing the digital images;
calculating an order completion time;
comparing the order completion time to a minimum default time;
setting a client wait time based on the greater of the order completion time and the minimum default time;
retrieving a store delay time;
comparing a sum of the order completion time and the store delay time to the minimum default time;
setting the order pick-up time to the client wait time if the sum of the order completion time and the store delay time is equal to or less than the minimum default time; and
setting the order pick-up time to a sum of the store delay time and the client wait time if the sum of the order completion time and the store delay time is greater than the minimum default time.

2. The method of claim 1, wherein the order completion time is calculated based on at least a number of digital images in the order and a size of the digital images in the order.

3. The method of claim 2, wherein the order completion time is calculated further based on a store set-up time.

4. The method of claim 2, wherein the order completion time is calculated further based on a bandwidth value.

5. The method of claim 1 further comprising:
associating the order pick-up time with a corresponding store location; and
displaying to a user, in response to a search for a store pick-up location, the order pick-up time along with a distance to the corresponding store location.

6. The method of claim 5, wherein the search for a store pick-up location includes a proximity criteria and wherein at least one store location is returned in response to the search.

7. The method of claim 6, wherein the proximity criteria is a value in miles from a zip code.

8. The method of claim 1, wherein the order for processing digital images includes a request for photographic prints.

9. The method of claim 1, wherein the order for processing digital images includes a request for printing the digital images on one or more items.

10. The method of claim 9, wherein the one or more items is a mug.

11. The method of claim 9, wherein the one or more items is a t-shirt.

12. The method of claim 9, wherein the one or more items are a novelty item.

13. A method for presenting a store location for pick-up of an order for processing digital images; the method comprising:
receiving the order at a centralized server system;
receiving a search request for the store location for pick-up, including a proximity criteria;
retrieving one or more store locations meeting the proximity criteria;
calculating an estimated pick-up time for each of the store locations meeting the proximity criteria; and
displaying to a user the estimated pick-up time along with a distance value based on the proximity criteria for each of the store locations.

14. The method of claim 13, wherein the step of calculating the estimated pick-up time comprises:
calculating an order completion time;
comparing the order completion time to a minimum default time;
setting a client wait time based on the greater of the order completion time and the minimum default time;
retrieving a store delay time;
comparing a sum of the order completion time and the store delay time to the minimum default time;
setting the estimated order pick-up time to the client wait time if the sum of the order completion time and the store delay time is equal to or less than the minimum default time; and
setting the estimated order pick-up time to a sum of the store delay time and the client wait time if the sum of the order completion time and the store delay time is greater than the minimum default time.

15. A system for presenting a selection of store pick-up locations comprising:
a centralized server system capable of communication with one or more end user computers to receive an order for processing digital images, the centralized server system further receiving a search request for a store pick-up location meeting a proximity criteria;
a network of digital image processing locations communicatively connected to the centralized server; each of the digital image processing locations having digital image processing characteristics; and
wherein an estimated pick-up time is calculated for each of the digital image processing locations meeting the proximity criteria based on an order completion time value.

16. The system of claim 15, wherein the order completion time is calculated based on at least a number of digital images in the order and a size of the digital images in the order.

17. The system of claim 16, wherein the order completion time is calculated further based on a store set-up time.

18. The system of claim 16, wherein the order completion time is calculated further based on a bandwidth value.

19. A system for presenting a selection of store pick-up locations comprising:
means for receiving an order for processing digital images from an end user computer;
means for retrieving a list of stores from a network of stores for processing digital images based on a proximity criteria received from the end user computer;
means for calculating an estimated order pick-up time based on an order completion time for each of the stores retrieved from the network of stores; and
means for displaying the list of stores meeting the proximity criteria on the end user computer along with the estimated order pick-up time for each of the stores in the list of stores.
